(19) United States
(12) Patent Application Publication
(10) Pub. No.: US 2005/0092124 A1
(43) Pub. Date: May 5, 2005

(54) Steering column unit for motor vehicles

(75) Inventors: Stephan Gaertner, Hamburg (DE); Peter Von Ey, Hamburg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/935,740

(22) Filed: Sep. 8, 2004

(30) Foreign Application Priority Data
Sep. 9, 2003 (DE) 103 41 419.3

(51) Int. Cl. B62D 1/18

(52) U.S. Cl. 74/495; 74/493

(57) ABSTRACT

A motor vehicle steering column unit includes a steering column, an adjusting device, which comprises a length adjusting mechanism for the length adjustment of the steering column and/or a tilt adjusting mechanism for the tilt adjustment of the steering column, as well as an electrical drive unit. The adjusting device has a central drive gear mechanically adjustable in at least two shift positions, which is powered by the electrical drive unit and is drivingly coupled in at least one of its shift positions with one or the other of the adjusting mechanisms.

This application claims the priority of German Patent Document No. 103 41 419.3, filed Sep. 9, 2003, the disclosure of which is expressly incorporated by reference herein.

### BACKGROUND AND SUMMARY OF THE INVENTION

The invention relates to a motor vehicle steering column unit.

DE 196 41 152 C2 discloses a motor vehicle steering column unit having a steering column housing and a steering column disposed therein, as well as an electrically powered adjusting device for the adjustment of the steering column for length and inclination (tilt). This adjusting device comprises an electrical drive unit for the torsional drive of a one-piece adjusting spindle, at least two spindle nuts disposed on the adjusting spindle, spindle nuts mounted for movement in the axial direction of the adjusting spindle, and at least one adjustment mechanism each for lengthwise movement and tilt adjustment. Furthermore, the adjusting device has a shifting device for each direction of movement, and a frictional engagement can be produced between the one shifting device and the spindle nut adjacent to the shifting device. The adjusting mechanisms for longitudinal movement and for the tilting movement are driven by a common adjustment spindle, the control of the adjusting mechanism being able to be performed by the engagement and disengagement of the switching devices arranged on the adjustment mechanisms. Thus a complete electrical drive unit is eliminated.

The present invention is directed to an improvement of a motor vehicle steering column unit of the kind mentioned in the beginning, which will have special advantages in regard to manufacturing costs, space needs and weight.

For a motor vehicle steering column unit with an adjustment device which comprises a length adjusting mechanism for the length adjustment of a steering column and/or a tilt adjusting mechanism for the tilt adjustment of the steering column, the invention provides in the adjusting device a central drive gear mechanically adjustable between at least two shift positions. This gear is driven by an electrical drive unit, and is drivingly coupled in at least one of its shift positions with the one or with the other adjusting mechanism.

In order to adjust the steering column lengthwise along its axis or change the tilt of the steering column, the adjustable central drive gear, which is driven by the electrical drive unit, is changed to a shifted position mechanically, i.e., for example through a lever disposed on a steering wheel, and thus actively connected either with the length adjusting mechanism or with the tilt adjusting mechanism. After the adjustment is made the central drive wheel is disengaged from the adjusting mechanism and the steering column is locked in the new position. The locking can be done, for example, by means of a locking lever or else more desirably by a self-locking design of the adjusting mechanisms.

The solution offered by the invention thus offers the great advantage of operating all of the adjusting mechanisms with only a single drive unit. Considerable reductions can thus be achieved regarding manufacturing costs, weight and the space required by the motor vehicle steering column unit. At the same time, on account of the reduced number of components involved, ease of maintenance is improved, and probability of failure is reduced. Because of ease of the operation of the motor vehicle steering column unit according to the invention, greater operating convenience is achieved.

The mechanically adjustable central drive gear permits easy changing of the switch positions without requiring expensive electronic switching units. At the same time, due to the elimination of electrical or electronic components or their replacement by mechanical components, the reliability and sturdiness of the motor vehicle steering column unit are definitely increased.

Furthermore, it is surprising that the solution offered by the invention comprises in a standard version only one longitudinal adjustment mechanism and one tilt adjustment mechanism. In higher level equipment lines or versions, however, both adjustment mechanisms can be provided, so that the solution offered by the invention can also be provided for use in various models of steering columns. This in turn increases the potential range of application and thereby permits a more widespread use of the invention.

In a preferred embodiment the two shift positions are associated with opposite directions of the lengthwise adjustment and/or the two shift positions are associated with opposite adjustment directions of the tilt setting. This offers the advantage that a single drive unit can be used, which powers the drive gear in only one direction of rotation and changing the direction of adjustment is made simply by varying the shift position of the mechanically adjustable central drive gear. The setting of the direction of adjustment can thereby be performed in a purely mechanical manner, for example by means of a lever without the need for reversing the direction of rotation of the drive unit or drive gear via an electronic control unit.

Alternatively, only two shift positions can be provided, the one shift position being associated with the length adjustment and the other shift position with the tilt adjustment. In this case it is necessary for the drive unit to be reversible in sense of rotation and to have a switch to control the direction of rotation. According to this alternative a direction of rotation switch is of course necessary, but on the other hand the number of shift positions can be halved, so that the design of the motor vehicle steering column unit is simplified. The switch for controlling the direction of rotation or reversing of the direction of rotation of the drive unit is relatively easy to achieve and, on account of the advantages of thereby eliminating at least one shift position, it results in a cost advantage and advantages in regard to the space requirements of the motor vehicle steering column unit.

According to an advantageous further development of the motor vehicle steering column unit, the switch for controlling direction of rotation can be integrated into the lever for the mechanical adjustment of the central drive gear. This lever can be handily arranged on the steering wheel of the motor vehicle, and thus can be operated single-handedly and simply, simultaneously with the lever, so that great convenience of operation is achieved.

According to another embodiment of the invention, at least one of the control mechanisms can have a flexible shaft for the transmission of power. This offers the advantage that the control mechanisms do not have to be arranged directly on the adjusting device and therefore they can be arranged at especially desirable locations. The flexible shaft assures a reliable and tight transmission of force thereby definitely increasing the number of positions for the installation of the adjustment mechanisms.

An especially advantageous embodiment of the solution according to the invention provides for constructing the central drive gear and an input end of the particular adjusting mechanism as complementary toothed gears. Toothed gears are widely used in transmission engineering, are highly precise and reliable transmission means, and can also be made at moderate cost and in virtually any form. Alternatively to complementary gears, the central drive gear and the input end of the particular adjusting mechanism can have a force transmitting coating. Such force transmitting coatings can be, for example, anti-slip coatings such as rubber.

It is evident that the features referred to above and to be explained below can be used not only in the combination stated in each case, but also in other combinations or alone, without departing from the scope of the present invention.

Other objects, advantages and novel features of the present invention will become apparent from the following detailed description of the invention when considered in conjunction with the accompanying drawings.

### BRIEF DESCRIPTION OF THE DRAWINGS

FIG. 1 is a representation of the principle of a motor vehicle steering column unit according to the invention,

FIG. 2 is a top plan view of a shifting apparatus according to the invention,

FIG. 3 is a representation as in FIG. 2, but in a side view.

### DETAILED DESCRIPTION OF THE DRAWINGS

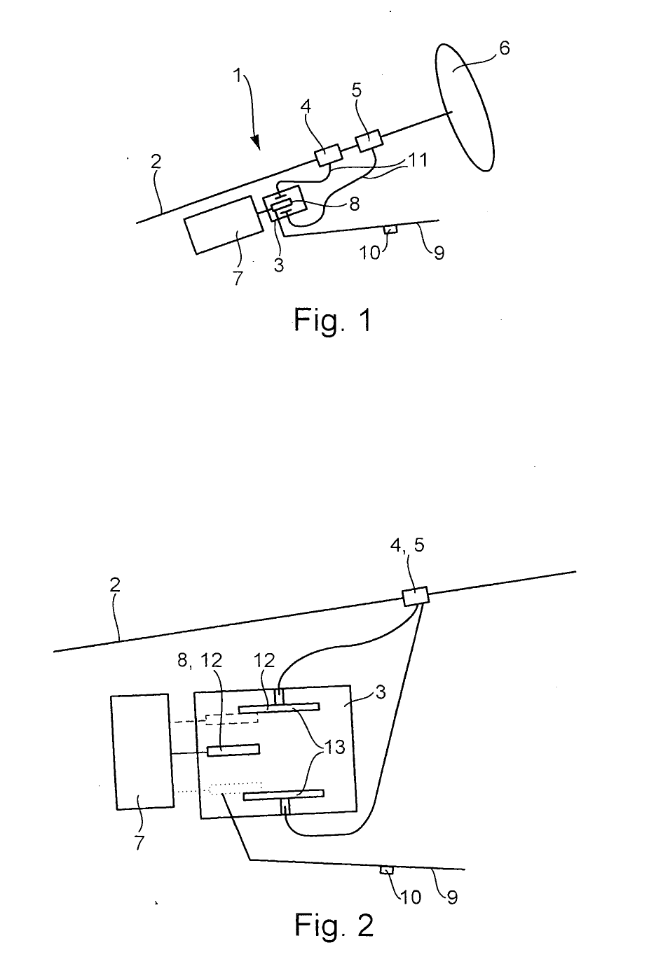

In FIG. 1 a motor vehicle steering column unit 1 according to the invention has a steering column 2 as well as an adjusting device 3 which includes a length adjusting mechanism 4 for the longitudinal adjustment of the steering column 2 in the direction of its length, and/or a tilt adjusting mechanism 5 for adjusting the tilt of the steering column 2. The adjusting device 3 permits an optimum adaptation of a position of the steering wheel 6 to individual requirements of a driver not shown.

The adjusting device 3 has a central driving gear 8 which can be rotated mechanically between at least two positions (cf. FIG. 2) and which is powered by an electrical power unit 7. The power unit 7 can be a conventional electric motor. According to the invention the central driving gear 8 can be rotated mechanically such that, in at least one of its positions, it is drivingly coupled with one of the two adjusting mechanisms 4 or 5.

The rotation of the central driving gear 8 to a steering position or to a neutral position, which according to FIG. 2 lies between the two steering positions, is performed through a shift lever 9 which is best arranged such that it can be easily operated by the driver of the vehicle. Easy operation is achieved, for example, by arranging the shift lever 9 close to the steering wheel 6.

In the neutral position, the central driving gear 8 is disengaged from the adjusting mechanisms 4 and 5, so that neither longitudinal adjustment nor tilt adjustment of the steering column 2 takes place. The central driving gear 8 can then be powered either constantly, i.e., also in the neutral position, or else only when it is changed to a steering position. In the case of a power unit 7 that can be engaged or disengaged the neutral position can be fundamentally omitted.

In general, several embodiments of the adjusting device 3 can be imagined. In FIG. 2 a variant is represented, in which the two adjustment positions are associated with opposite adjustment directions of the longitudinal adjustment or longitudinal adjustment mechanism 4 and/or of the tilt adjusting mechanism 5. Such an embodiment makes it possible for the power unit 7 to drive the driving gear 8 in only one direction of rotation. A reversal of the direction of adjustment of the longitudinal adjustment or tilt adjustment is thus accomplished by a turning of the driving gear 8 from a first position (broken line) through the neutral position (solid line) to a second position (dotted line) or the reverse.

On the other hand, according to the exemplary representation in FIG. 1, however, it is also possible to provide only two shift positions, wherein the one shift position is associated with the length adjustment and the other with the tilt adjustment. This embodiment requires a reversible power unit 7 and thus a reversible driving gear 8. To change the direction of rotation a switch 10 is provided, which is integrated into the shift lever 9 (cf. FIGS. 1 and 2) and thereby improves the functionality of the shift lever 9. Also conceivable, however, is an arrangement of the switch 10 at another ergonomically desirable point on the steering wheel 6 or at sone other part of the instrument panel not shown.

According to FIG. 1 and FIG. 2, the adjusting mechanisms 4 and 5 have each a flexible shaft 11 for the transmission of force. This makes it possible for the longitudinal adjustment mechanism 4 and/or the adjustment mechanism 5 to be arranged on the steering column 2 regardless of the position of adjustment device 3. Thus it is possible to divide up the basically complete adjusting device 3 into several component groups and arrange them independently of one another at especially beneficial locations. Moreover, the possibility is thus created for producing different motor vehicle steering column units 1 for different models, for example in a standard version in which only one adjusting mechanism 4 or 5 is provided, and in a higher-value version in which both adjustment mechanisms 4 and 5 are provided. In order to convert the motor vehicle steering column unit 1 from the standard version to the higher-value version, all that is needed is to connect the second adjusting mechanism 4 or 5 via the flexible shaft 11 to the adjusting apparatus 3, provided the latter is prepared for connection of the second adjusting mechanism 4 or 5.

To operate the shift lever 9 or when shifting the drive gear 8 to a position in which it is drivingly coupled with the shifting mechanism 4 or 5, a power transferring connection can be provided between the central driving gear 8 and an input side 13 of the adjusting mechanism 4 or 5. In this case, according to a possible embodiment, provision can be made for configuring the central drive gear 8 and the input side 13 of the particular adjusting mechanism 4 or 5 as complementary gears 12. These are brought into engagement by operating the shift lever 9 and thus produce a force-transmitting connection between the central drive gear 8 and the input side 13 of the particular adjusting mechanism 4 or 5.

Alternatively it is conceivable for the central drive gear 8 and the input side 13 of the adjusting mechanism 4 or 5 to have a force transferring coating, for example a slip-resistant coating of rubber. In this way too a force transferring coupling can be achieved between the central drive gear 8 and the adjusting mechanism 4 or 5 when they are changed to a shifted position.

It is important in this case that, by means of the shift lever 9 it is possible to change the shift positions of the central driving gear 8, in which it comes into engagement with the input sides 13 of the particular adjusting mechanism. It is not important whether the central driving gear 8 is moved by the shift lever 9 against fixed input sides 13 or whether vice-versa the input sides 13 are shifted against the fixed central driving gear 8.

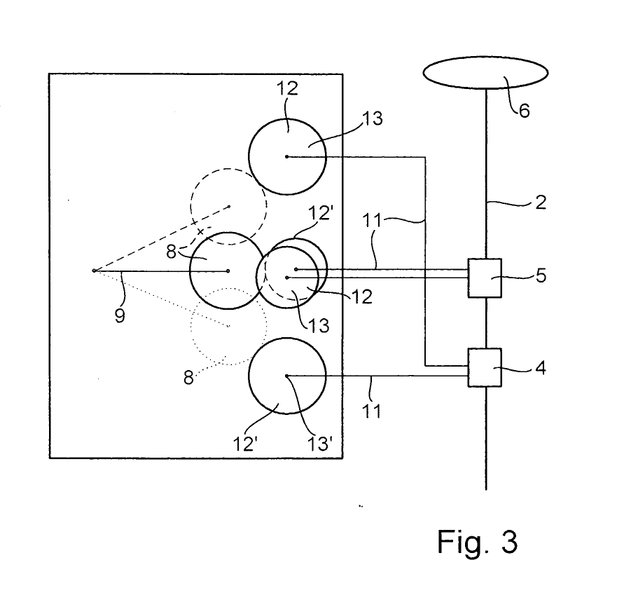

In FIG. 3 an additional variant embodiment of the adjusting device 3 is shown. To operate the length adjusting mechanism 4, here the central driving gear 8, always revolving in the same direction, is shifted from the neutral position (solid line) to the first shift position (broken line). In this position the driving gear 8 is drivingly coupled to the input side 13, for example to the gear 12 of the length adjustment mechanism 4. If the shift is completed the central driving gear 8 is transferred from the first engagement position (broken line) to the neutral position (solid line). To reverse the shift direction, the central driving gear 8 is shifted to the second position (dotted line) and thereby drivingly connected for example with an additional gear 12′ at the input side 13 of the length adjustment mechanism 4.

To operate the tilt mechanism 5, according to FIG. 3 the central drive gear 8, in its neutral position with respect to the length adjusting mechanism 4, is shifted perpendicular to the plane of drawing. Thus the drive gear 8 is drivingly engaged either with the gear 12 or 12′, both of which are disposed on the input end to the tilt adjusting mechanism 5. To produce a reversal of the setting direction of the tilt adjusting mechanism 5, the drive gear 8 is shifted from a position pressed into the plane of drawing (drivingly joined to gear 12′) to a position drawn out of the plane of drawing (drivingly joined position of the drive gear 12). Between the joined position of the drive gear 8 driving gear 12′ is the neutral position in which the tilt adjusting mechanism 5 is not actuated.

Similarly to FIGS. 1 and 2, the length adjusting mechanism 4 and the tilt adjusting mechanism 5 have flexible shafts 11 for force transmission.

For a motor vehicle steering column unit 1, the invention proposes a shifting device 3 with which a length adjustment or a tilt adjustment of a steering column 2 can be made, and which has a mechanically shiftable central drive gear between at least two shift positions. The central drive gear 8 is drivingly coupled to the one or the other adjusting mechanism 4 or 5 in at least one of its positions.

The solution according to the invention thereby offers the advantage of driving a plurality of adjusting mechanisms 4, 5 with only a single driving unit 7, so that any additional drive unit is unnecessary and costs can be saved. At the same time the adjusting mechanisms 4 and 5 are arranged separately from the adjusting device 3 and are connected to the latter by flexible shafts, so that they can be arranged on the steering column 2 independently of the position of the adjusting device 3. Thus the possibility is also offered of manufacturing different series, for example a standard version or a full version of the motor vehicle steering column unit 1, and of installing them with the desired equipment in the motor vehicle being manufactured.

The shifting of the drive gear 8 to a position is performed by a mechanical lever 9, so that unreliable and expensive electronic switchgear can be avoided.

1. A motor vehicle steering column unit comprising:
a steering column;
an electrical driving unit;
a shifting apparatus including
a length adjusting mechanism for adjusting the length of the steering column,
a tilt adjusting mechanism for adjusting the tilt of the steering column, and
a central driving gear, which is driven by the electrical driving unit, is mechanically shiftable between at least two shifting positions, wherein the central driving gear in at least one of its shift positions is drivingly coupled with one of the shifting mechanisms.

2. The motor vehicle steering column unit according to claim 1, wherein the two shift positions are associated with at least one of (a) opposite directions of the length adjustment and (b) opposite directions of the tilt adjustment.

3. The motor vehicle steering column unit according to claim 2, wherein the driving unit of the drive gear drives only in one direction of rotation.

4. The motor vehicle steering column unit according to claim 3, wherein at least one of the shift positions is associated with the length adjustment and at least one of the shift positions is associated with the tilt adjustment.

5. The motor vehicle steering column unit according to claim 1, wherein the central driving gear has only two shift positions, wherein one of the shift positions is associated with the length adjustment while the other shift position is associated with the tilt adjustment, and wherein the driving unit is reversible and has a switch to control direction of rotation.

6. The motor vehicle steering column unit according to claim 4, wherein the adjusting device has a lever for the mechanical shifting of the central drive gear.

7. The motor vehicle steering column unit according to claim 6, wherein the switch for changing direction of rotation is integrated into the lever.

8. The motor vehicle steering column unit according to claim 7, wherein at least one of the shift mechanisms has a flexible shaft for transmission of force.

9. The motor vehicle steering column unit according to claim 8, wherein the central drive gear and an input end of at least one of the shifting mechanisms are complementary gears.

10. The motor vehicle steering column unit according to claim 8, wherein the central drive gear and an input end of at least one of the shifting mechanisms have a force transmitting coating.

11. The motor vehicle steering column unit according to claim 1, wherein at least one of the shift positions is associated with the length adjustment and at least one of the shift positions is associated with the tilt adjustment.

12. The motor vehicle steering column unit according to claim 1, wherein the adjusting device has a lever for the mechanical shifting of the central drive gear.

13. The motor vehicle steering column unit according to claim 12, wherein the switch for changing direction of rotation is integrated into the lever.

14. The motor vehicle steering column unit according to claim 1, wherein at least one of the shift mechanisms has a flexible shaft for transmission of force.

15. The motor vehicle steering column unit according to claim 1, wherein the central drive gear and an input end of at least one of the shifting mechanisms are complementary gears.

16. The motor vehicle steering column unit according to claim 1, wherein the central drive gear and an input end of at least one of the shifting mechanisms have a force transmitting coating.

17. A method for making a motor vehicle steering column unit comprising the step of:
drivingly coupling a central driving gear, which is driven by an electrical driving unit, of a shifting apparatus in at least one of the central driving gear's mechanically shiftable shift positions with one of a length adjusting mechanism of the shift apparatus for adjusting the length of a steering column and a tilt adjusting mechanism of the shift apparatus for adjusting the tilt of a steering column.

18. The method according to claim 17, further comprising the step of associating the two shift positions with at least one of (a) opposite directions of the length adjustment and (b) opposite directions of the tilt adjustment.

19. The method according to claim 18, wherein the driving unit of the drive gear drives only in one direction of rotation.

20. The method according to claim 19, further comprising the steps of associating at least one of the shift positions with the length adjustment and associating at least one of the shift positions with the tilt adjustment.
the central drive gear and an input end of the particular shift mechanism have a force transmitting coating.
